(19) United States
(12) Patent Application Publication
(10) Pub. No.: US 2015/0375380 A1
(43) Pub. Date: Dec. 31, 2015

(54) TORQUE WRENCH WITH A REFLECTION-TYPE VIEWING WINDOW ILLUMINATION STRUCTURE

(71) Applicant: TORQUE-TECH PRECISION CO., LTD., Taichung (TW)

(72) Inventor: Tien-Lung LIN, Taichung (TW)

(21) Appl. No.: 14/314,569

(22) Filed: Jun. 25, 2014

(51) Int. Cl. B25B 23/142; F21V 23/02; F21L 4/00; F21V 33/00; F21V 23/04

(52) U.S. Cl. CPC B25B 23/1422; F21V 33/0084; F21V 23/04; F21L 4/00; F21V 23/023

(57) ABSTRACT

A torque wrench with a reflection-type viewing window illumination structure in the present invention includes a wrench body having an outer surface bored with a viewing window provided therein with an indicating member. A luminous member is installed at a location adjacent to the viewing window, and a control unit is electrically connected with the luminous member. Thus, the luminous member can be started by the control unit to carry out illumination toward the interior of the viewing window for lighting up the indicating member so as to enable a user to clearly read the indicating member in an environment of insufficient light and really know the torsion value that the wrench body sets at the very moment.

### BACKGROUND OF THE INVENTION

1. Field of the Invention

This invention relates to a torque wrench, particularly to one provided with a reflection-type viewing window illumination structure.

2. Description of the Prior Art

A conventional mechanical torque wrench generally includes a wrench body provided thereon with a torsion value adjustment mechanism for adjusting the torsion value output by the torque wrench and, for facilitating a user to really know the torsion value the torque wrench sets at the very moment, the torque wrench has an outer surface bored with a viewing window having its interior disposed with an indicating member, such as a graduation indicator or a digit turning wheel set, so that the user can directly understand the current torsion value set at the present time by observing the indicating member via the viewing window.

However, when a user operates the conventional torque wrench in an environment of insufficient light, the user is unable to read and discriminate the indicating member and at this time, the user has to employ auxiliary apparatus like a flashlight to illuminate the viewing window to enable the user to interpret the indicating member, thus very inconvenient in operating. Probably, a digital torque wrench can be provided thereon with a liquid crystal display to substitute for the viewing window for overcoming the above-mentioned shortcoming of the conventional torque wrench that insufficient light affects interpretation of the indicating member. Nevertheless, the digital torque wrench is high in cost, complicated in structure, and the electronic parts are easy to be damaged when the digital torque wrench causes collision so the digital torque wrench is inferior to the mechanical torque wrench in durability. In view of the defects of the conventional torque wrench, the inventor of this invention thinks it is necessary to research and develop an illumination structure to be used for the viewing window of a mechanical torque wrench and hence devises this invention.

### SUMMARY OF THE INVENTION

The objective of this invention is to offer a torque wrench with a reflection-type viewing window illumination structure, provided with a luminous member for illuminating the viewing window of a wrench body so that a user is able to clearly read and understand a torsion value that the torque wrench sets at present in an environment of insufficient light.

The torque wrench with a reflection-type viewing window illumination structure in the present invention includes a wrench body having its outer surface bored with at least one viewing window assembled therein with an indicating member. At least one luminous member is installed at a location adjacent to the viewing window to carry out illumination toward the interior of the viewing window for lighting up the indicating member. A control unit combined with the wrench body is electrically connected with the luminous member and provided with a switch for controlling the luminous member to be turned on and off and at least one battery for supplying electricity.

When using the torque wrench of this invention in an environment of insufficient light, a user can press and start the switch to turn on the luminous member to carry out illumination toward the interior of the viewing window for lighting up the indicating member. Thus, the user can clearly read and discriminate the indicating member and surely understand a torsion value the torque wrench sets at the very moment, able to get rid of the defect of the conventional torque wrench that extra illumination apparatus like a flashlight needs to be used in a dim environment.

### BRIEF DESCRIPTION OF DRAWINGS

This invention will be better understood by referring to the accompanying drawings, wherein:

FIG. 1 is a perspective view of a first preferred embodiment of a torque wrench with a reflection-type viewing window illumination structure in the present invention;

FIG. 2 is a partial exploded perspective view of the first preferred embodiment of the torque wrench with a reflection-type viewing window illumination structure in the present invention;

FIG. 3 is a partial cross-sectional view of the first preferred embodiment of the torque wrench with a reflection-type viewing window illumination structure in the present invention;

FIG. 4 is an exploded perspective view of the first preferred embodiment of a control unit in the present invention;

FIG. 5 is a perspective view of a second preferred embodiment of a torque wrench with a reflection-type viewing window illumination structure in the present invention;

FIG. 6 is a cross-sectional view of the second preferred embodiment of the torque wrench with a reflection-type viewing window illumination structure in the present invention;

FIG. 7 is a perspective view of a third preferred embodiment of a torque wrench with a reflection-type viewing window illumination structure in the present invention; and

FIG. 8 is a partial exploded perspective view of the third preferred embodiment of the torque wrench with a reflection-type viewing window illumination structure in the present invention.

### DETAILED DESCRIPTION OF THE PREFERRED EMBODIMENT

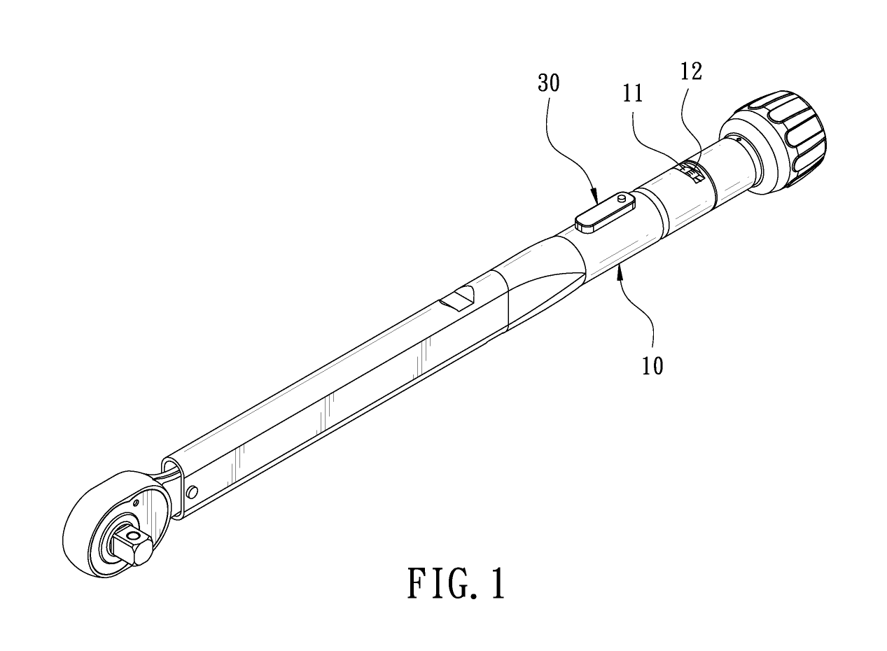

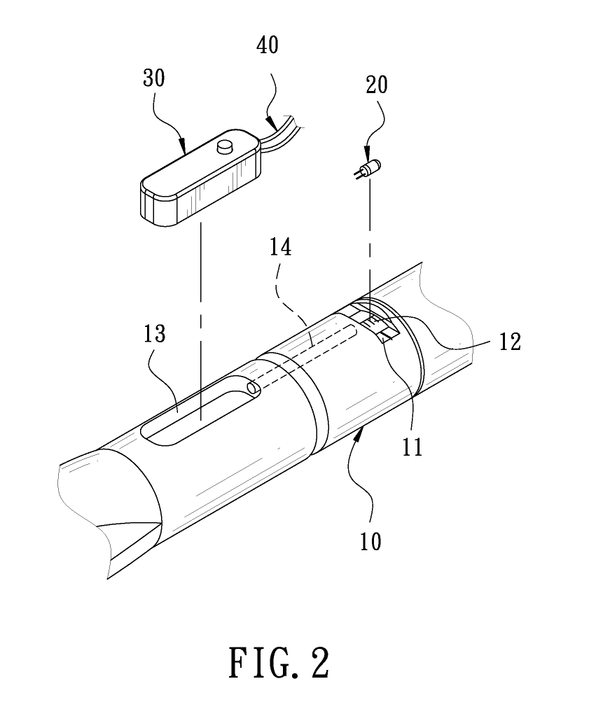

A first preferred embodiment of a torque wrench with a reflection-type viewing window illumination structure in the present invention, as shown in FIGS. 1, 2 and 3, includes a wrench body 10, at least one luminous member 20, a control unit 30 and plural electric wires 40 as main components combined together.

The wrench body 10 has an outer surface bored with at least one viewing window 11 having its interior provided with an indicating member 12 for showing a torsion value the wrench main body 10 sets at the very moment. In this preferred embodiment, the wrench body 10 is formed thereon with one viewing window 11, while the indicating member 12 is a graduation indicator. The wrench body 10 is further disposed with a combination groove 13 in the vicinity of the viewing window 11, having a passageway 14 formed between and communicating with the viewing window 11 and the combination groove 13.

The luminous member 20 is set at a location adjacent to the viewing window 11 to emit light toward the interior of the viewing window 11 for illuminating the indicating member 12. In this preferred embodiment, one luminous member 20, which is a light emitting diode, is installed in the passageway 14 at a location near the viewing window 11.

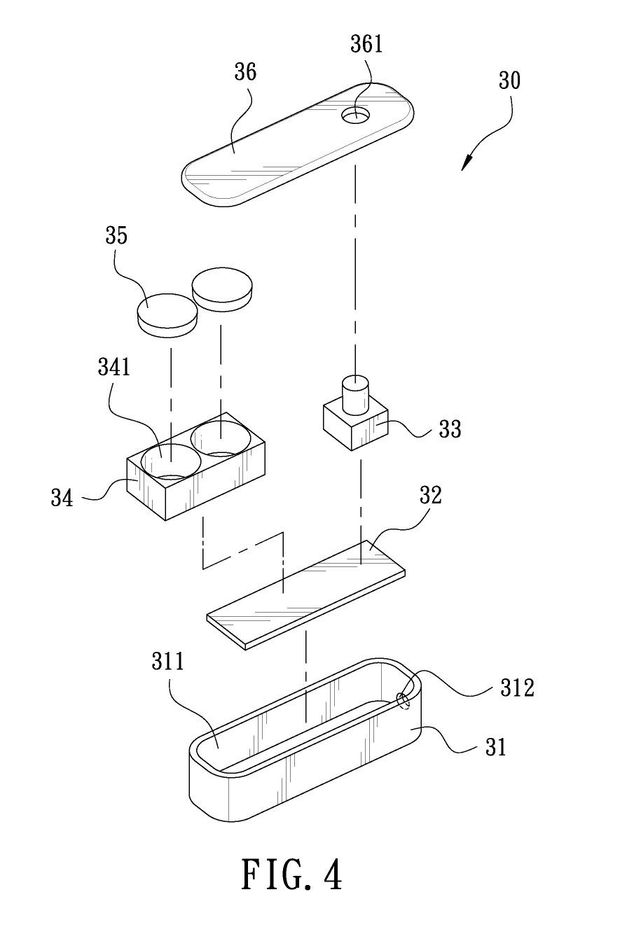

The control unit 30, referring to FIGS. 1-4, is combined with the wrench body 10 and provided with a housing 31. In this preferred embodiment, the housing 31 has its lower half portion received in the combination groove 13 and its upper half portion exposed out of the combination groove 13. The housing 31 has one side recessed and formed with an accommodating groove 311 and an outer side bored with a through hole 312 communicating with the accommodating groove 311, and a circuit bored 32, a switch 33, a battery box 34 and at least one battery 35 are all received in the interior of the accommodating groove 311. The switch 33 functions to turn on and off the luminous member 20 and in this preferred embodiment, a button switch is optionally employed as the switch 33 that is assembled on the circuit board 32. The battery box 34 is positioned on the circuit board 32 and formed with at least one battery groove 341, and the battery 35 for supplying electricity is received in the battery groove 341 of the battery box 34 that is assembled on the circuit board 32, letting the switch 33 and the battery 35 electrically connected by means of the circuit board 32. In addition, the control unit 30 contains a cover 36, which is hermetically covered on the accommodating groove 311 and bored with a through hole 361 corresponding to the switch 33 for the button of the switch 33 to be inserted therethrough.

The electric wires 40 are inserted in the passageway 14 and positioned between the luminous member 20 and the control unit 30 for electrically connecting both the luminous member 20 and the control unit 30. In this preferred embodiment, the electric wires 40 respectively have one end directly connected with the luminous member 20 and another end inserted through the through hole 312 of the housing 31 and connected with the circuit board 32, letting the luminous member 20 and the control unit 30 electrically connected.

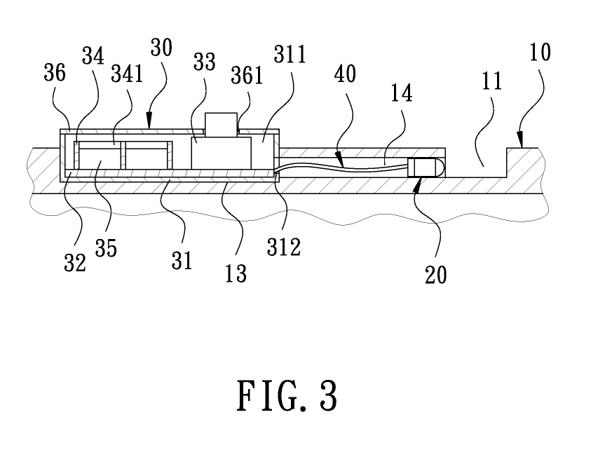

In using, referring to FIG. 3, when a user operates the wrench body 10 in an environment of insufficient light, the user can press the switch 33 to have the electricity that is supplied by the battery 35 transmitted to the luminous member 20 via the electric wires 40 for starting the luminous member 20 to carry out illumination toward the interior of the viewing window 11, letting the light illuminate the indicating member 12 first and then reflected out of the viewing window 11 for lighting up the indicating member 12. Thus, a user is able to clearly read the indicating member 12 in an environment of insufficient light so that the user can really know the torsion value that the wrench body 10 sets at the present time. Therefore, this invention can get rid of the drawback of the conventional torque wrench that needs a flashlight or the like to be an illumination auxiliary apparatus when employed in a dim environment, greatly enhancing convenience in operation.

One special feature of this invention is that both the electric wires 40 and the luminous member 20 are assembled in the passageway 14, able to beautify the external appearance of the wrench body 10 and protect both the electric wires 40 and the luminous member 20 from being damaged by an external accident.

Although the luminous member 20 of this invention is not restricted in its location, yet if the luminous member 20 is installed outside the viewing window 11, scattered light emitted by the luminous member 20 is apt to interfere with reflecting light reflected by the indicating member 12 and thus affects a user's interpretation of the indicating member 12. Therefore, the luminous member 20 in this preferred embodiment is mounted in the passageway 14 and hence, light emitted by the luminous member 20 can be sure to illuminate the indicating member 12 first and then be reflected out of the viewing window 11, able to greatly lower interference of the scattered light to enable a user to read and discriminate the indicating member 12 with easiness.

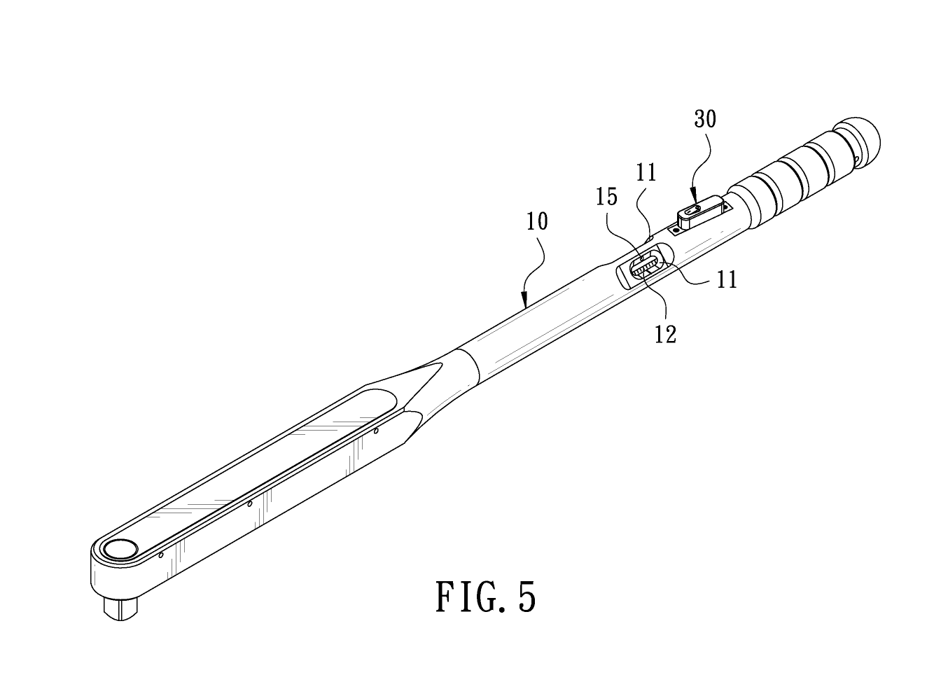

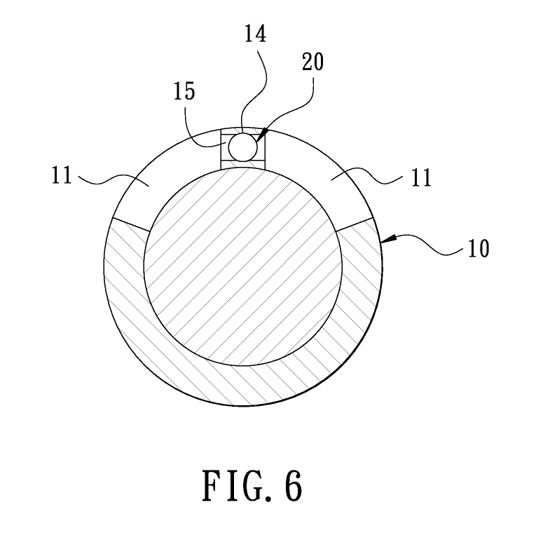

A second preferred embodiment of a torque wrench with a reflection-type viewing window illumination structure in the present invention, as shown in FIGS. 5 and 6, is to have the wrench body 10 provided with two viewing windows 11 and an insert hole 15 communicating with the two viewing windows 11. The passageway 14 is positioned between the two viewing windows 11 and communicates with an insert hole 15, and the luminous member 20 is installed at the connecting point of the passageway 14 and the insert hole 15. Further, the control unit 30 is directly secured at the outer surface of the wrench body 10 and a locker switch is optionally used as the switch 33. Thus, when the luminous member 20 begins to emit light, the light will pass through the insert hole 15 and illuminate the viewing windows 11 at two sides of the passageway 14, thus achieving the same effect that a user can clearly read the indicating member 12 in an environment of insufficient light as that described in the first preferred embodiment.

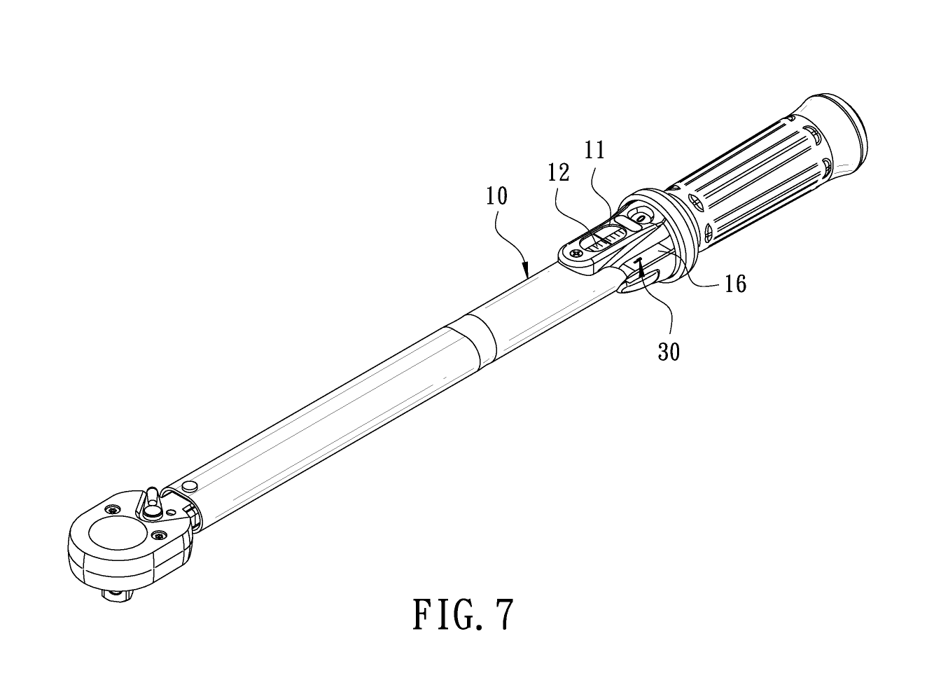

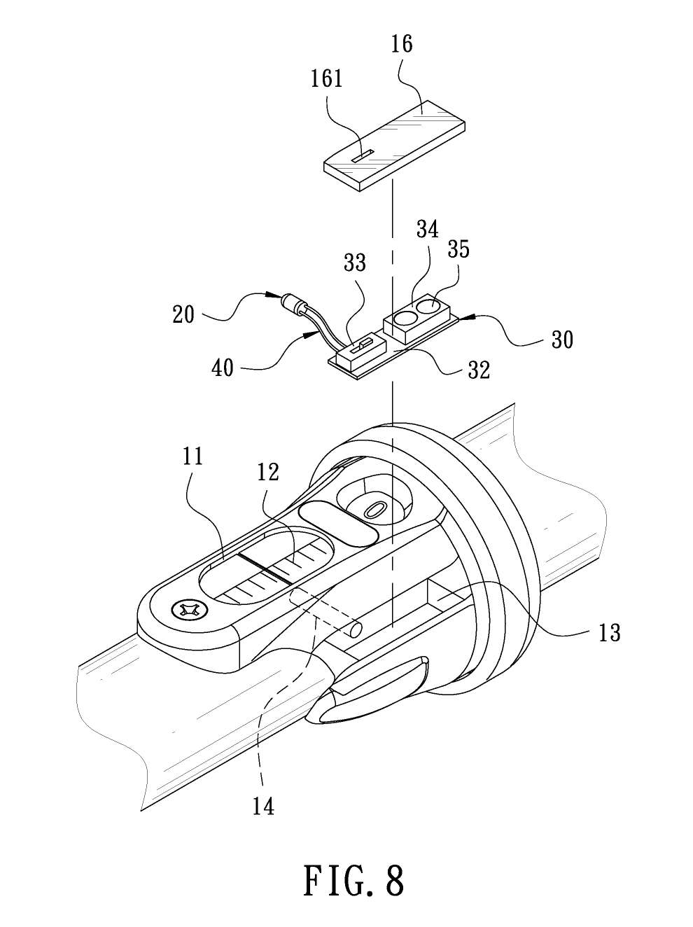

A third preferred embodiment of a torque wrench with a reflection-type viewing window illumination structure in the present invention, as shown in FIGS. 7 and 8, is to have the circuit board 32, which is assembled thereon with the switch 33, the battery box 34 and the battery 35, directly received in the combination groove 13 of the wrench body 10. A dip switch is optionally employed as the switch 33, and an outer cover 16 is covered at the outer side of the combination groove 13 and bored with a slot 161 for the actuating rod of the dip switch to be inserted therethrough. Thus, the whole control unit 30 can be directly inlaid in the wrench body 10, able to unify the external looks of the wrench body 10 and equally attain the effect that a user is able to clearly read the indicating member 12 in a dim environment as described in the first preferred embodiment.

While the preferred embodiments of the invention have been described above, it will be recognized and understood that various modifications may be made therein and the appended claims are intended to cover all such modifications that may fall within the spirit and scope of the invention.

What is claimed is:

1. A torque wrench with a reflection-type viewing window illumination structure comprising:
a wrench body, said wrench body having an outer surface bored with at least one viewing window, said viewing window provided therein with an indicating member, said indicating member showing a torsion value that said wrench body sets at the very moment;
at least one luminous member, said luminous member installed at a location adjacent to said viewing window, said luminous member carrying out illumination toward said viewing window by lighting up said indicating member; and
a control unit, said control unit combined with said wrench body and electrically connected with said luminous member, said control unit provided with a switch for turning on and off said luminous member to be turned on and off, said control unit containing at least one battery for supplying electricity.

2. The torque wrench with a reflection-type viewing window illumination structure as claimed in claim 1, wherein said indicating member is a graduation indicator.

3. The torque wrench with a reflection-type viewing window illumination structure as claimed in claim 1, wherein said wrench body is formed with a passageway communicating with said viewing window and provided with a plurality of electric wires, said electric wires inserted through said passageway and connected between said luminous member and said control unit, said electric wires electrically connected with both said luminous member and said control unit.

4. The torque wrench with a reflection-type viewing window illumination structure as claimed in claim 3, wherein said wrench body is bored with two viewing windows and an insert hole communicating with said two viewing windows, said passageway formed between said two viewing windows and communicating with said insert hole.

5. The torque wrench with a reflection-type viewing window illumination structure as claimed in claim 3, wherein said luminous member is assembled in said passageway.

6. The torque wrench with a reflection-type viewing window illumination structure as claimed in claim 4, wherein said luminous member is set at a connecting point of said passageway and said insert hole.

7. The torque wrench with a reflection-type viewing window illumination structure as claimed in claim 1, wherein said control unit contains a circuit board, and said switch element and said battery are assembled on said circuit board, said switch and said battery electrically connected via said circuit board.

8. The torque wrench with a reflection-type viewing window illumination structure as claimed in claim 7, wherein said control unit further contains a battery box, said battery box positioned on said circuit board and disposed with at least one battery groove, said battery received in said battery groove.

9. The torque wrench with a reflection-type viewing window illumination structure as claimed in claim 8, wherein said control unit further includes a housing, said housing having one side recessed and formed with an accommodating groove, said circuit board, said switch element, said battery box and said battery all received in said accommodating groove, said control unit also consisting of a cover to be hermetically covered on said accommodating groove.

10. The torque wrench with a reflection-type viewing window illumination structure as claimed in claim 9, wherein said wrench body is formed with a combination groove, said housing having a lower half portion received in said combination groove and an upper half portion exposed out of said combination groove.
